(19) United States
(12) Patent Application Publication
(10) Pub. No.: US 2025/0303284 A1
(43) Pub. Date: Oct. 2, 2025

(54) CINEMATIC REPLAY SYSTEM

(71) Applicant: Electronic Arts Inc., Redwood City, CA (US)

(72) Inventors: Ravinder S. Harry, Langley (CA); Donghwan Kim, Coquitlam (CA)

(21) Appl. No.: 18/618,298

(22) Filed: Mar. 27, 2024

(51) Int. Cl. A63F 13/497; A63F 13/52

(52) U.S. Cl. CPC A63F 13/497; A63F 13/52

(57) ABSTRACT

A gaming system may allow for a user to capture simulation state data of gameplay in a video game such that, upon occurrence of a cinematic rendering event, a cinematic rendered views of the gameplay may be rendered. Specifically, the gaming system may receive simulation state data and determine based thereon that a cinematic rendering event occurred. The gaming system may then receive previously stored simulation state data and render and output a plurality of cinematic rendered views based at least in part on a cinematic rendering timeline, the one or more simulation states of the simulation state data, and the one or more prior simulation states of the previously stored simulation state data. The cinematic rendering timeline may include a first shot and a second shot which include different configurations for rendering corresponding portions the plurality of cinematic rendered views.

### BACKGROUND

Video gaming allows for players to play a variety of electronic and/or video games alone or with each other via network connectivity, such as via the Internet. With the rise of near photorealistic games which may have real life analogs (e.g., eSports), players may desire an experience similar to the real world analog. However, frustration may arise due to the lack of depth or visceral feeling given by the gameplay view, such as at important moments in gameplay.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a schematic diagram of an example environment with game system(s), matchmaking system(s), and game client device(s) that may provide for capturing simulation state data of gameplay in a video game such that a cinematic replay of the gameplay may be rendered and/or presented, in accordance with example embodiments of the disclosure.

FIG. 2 illustrates a schematic diagram of an example game client device that may include functionality for simulation state data capture and cinematic replay generation, in accordance with example embodiments of the disclosure.

FIG. 3 illustrates a diagram of a camera configuration for a shot of a cinematic timeline, in accordance with example embodiments of the disclosure.

FIGS. 4A and 4B illustrate views of a match in a boxing video game the moment before and the moment after a cinematic event occurs, respectively, in accordance with example embodiments of the disclosure.

FIG. 5 illustrates a flow diagram of an example method that may provide for capture of simulation state(s) from gameplay of a player and for rendering of a cinematic replay of the gameplay, for example, upon occurrence of a gameplay event, in accordance with example embodiments of the disclosure.

FIG. 6 illustrates a block diagram of example game client device(s) that may provide for capturing simulation state(s) from gameplay of a player and for rendering a cinematic replay of the gameplay, in accordance with examples of the disclosure.

### DETAILED DESCRIPTION

Example embodiments of this disclosure describe methods, apparatuses, computer-readable media, and system(s) for providing a cinematic replay system for video gaming. More particularly, example methods, apparatuses, computer-readable media, and system(s) according to this disclosure may capture simulation state data of gameplay in a video game such that a cinematic replay of the gameplay may be rendered, for example, upon occurrence of a gameplay event.

For example, during gameplay, a simulation state of the game may be maintained and updated by a simulation engine (also referred to herein as a simulation module). The simulation state may be used to render a view (or frame) that is presented to a player. In examples according to this disclosure, the simulation state may also be captured and stored. For example, the simulation state may be captured per view rendered by a rendering module and presented to the player on a display or at other frequencies. The simulation state may include positions and orientations of models and components of models within the simulation state, light sources, camera positions, and so on. Simulation state data, as used herein, may refer to a set of simulation states corresponding to a series of rendered views for a period of time that may be captured. The capturing and storing of simulation state data may be performed instead of or in addition to capturing the rendered views presented live to the player during gameplay.

The simulation module may operate to determine when one or more cinematic events occur in the simulation of the game. A cinematic event may be a type of event for which a cinematic timeline has been configured for rendering of the simulation state data associated with events of the type of event. For example, in operation of a mixed martial arts (MMA) fighting game, a cinematic event may be a fight ending blow, a fight ending grappling move, or otherwise notable action or period of time in the MMA fight. In some examples, a cinematic event may have additional characteristics or criteria. For example, fight ending kicks to the body of the losing character may be a different type of cinematic event from a fight ending punch to the head of the losing character. In the operation of a soccer game, a cinematic event may be a goal scoring kick or a type of blocking action of a defender (e.g., the goalie).

Once a cinematic event has been determined to have occurred, the simulation module may notify a cinematic rendering module about the cinematic event and cause a gameplay rendering module to stop rendering views for display. The simulation module may request cinematic timeline data from a cinematic timeline database for the type of cinematic event. Based on the cinematic timeline data for the type of cinematic event, the cinematic rendering module may request simulation data for a time range around the time of the cinematic event. For example, the cinematic rendering module may request simulation data for four seconds before the event and three seconds afterwards. Of course, these are merely examples and, as will be more clearly understood in view of the discussion below regarding cinematic timelines, any time range may be utilized for the length of cinematic replay desired for the type of cinematic event.

The cinematic rendering module may then utilize the cinematic timeline data and the simulation data to render a cinematic replay view of the cinematic event and/or present the rendered cinematic replay view to the player(s).

More particularly, the cinematic timeline data may include data for a cinematic sequence of “shot(s)” or track(s). A shot may involve a one or more characters that are animated to perform one or more actions in the cinematic replay, one or more cameras (e.g., virtual cameras of the game engine) that may act as viewpoints for the rendering of the cinematic replay views, lighting data for one or more lights that may illuminate the shot, time dilation data that may slow down or speed up the actions of the character (e.g., the passage of time in the cinematic replay), particle effects data, framing weight controls, and/or any other data for rendering the cinematic replay. The one or more cameras may be anchored in the virtual environment to a static location, an offset from a portion of a character or object, an offset from a midpoint of two or more characters or objects, and so on. The framing weight controls may weight the views toward and/or away from one or more of the character(s), object(s) or other location(s) in the virtual environment. At least some of the shot configuration to render cinematic replay views for a shot in the cinematic timeline may be independent of the configuration of the gameplay views that may be rendered during gameplay.

In an example, the cinematic replay may relate to a knockout punch of a MMA match. In such an example, the simulation state data may include models for the two MMA fighters and animation, movement, or pose information for the models over the course of the time range. A first shot of the cinematic timeline may include lights to highlight the two fighters while pitching the remainder of the arena in darkness, vary the playback speed throughout the shot to give bullet time or other slow motion effects (e.g., reduce playback speed as the hit connects while increasing particle effects (e.g., blood and sweat) and then increasing speed of playback as the losing character falls to the mat of the arena), vary the position or framing control of the camera(s) throughout the shot, and/or start, stop or modify the visual effects during the course of the shot). In some examples, the changes in the various parameters of the shot over the time period of the shot may be a smooth curve, stepped, continuous, linear and so on. For example, a time dilation parameter may be definable to modify the time dilation to rise from a near stop to a real time playback rate in a smooth geometric or exponential increase such that the playback speed increases slowly at first but, once the playback speed reaches half speed, increases rapidly until it reaches real time playback speed.

As the frames of the view of the shot are generated, the cinematic rendering module may output the cinematic replay view to a player via a display. At the end of the shot, the cinematic rendering module may begin rendering frames for the next shot of the cinematic replay. In some examples, each shot may be associated with a different portion of the time window of the cinematic event and/or may overlap. The process may continue for each shot of the cinematic timeline.

After the last shot of the timeline has been processed and output, the cinematic rendering module may notify the simulation module. The simulation module may then cause the main rendering to resume if the cinematic event was not the end of the gameplay or the simulation module may begin handling the post match score presentation or the like if the cinematic event ended the gameplay.

The cinematic replay techniques described herein can improve a functioning of a computing device by providing additional functions for gameplay experiences. As discussed above, the cinematic replay view of the captured gameplay provided by techniques herein may allow for greater depth, excitement, immersion and/or for a more memorable experience. For example, in a sports game context, the timeline to generate the cinematic replay views may be configured to provide views and/or an experience similar to a real world broadcast of the sport or a blockbuster movie about the sport. Further, because the systems and techniques herein capture simulation state data, the cinematic replay of the captured simulation state data may be freely adapted or customized to provide the greatest focus on the cinematic event being presented. These and other improvements to the functioning of the computer are discussed herein.

Certain implementations and embodiments of the disclosure will now be described more fully below with reference to the accompanying figures, in which various aspects are shown. However, the various aspects may be implemented in many different forms and should not be construed as limited to the implementations set forth herein. For example, some examples provided herein relate to sport, fighting or shooting games. Implementations are not limited to the example genres. It will be appreciated that the disclosure encompasses variations of the embodiments, as described herein. For example, while the rendering and cinematic rendering are illustrated as being performed by different modules herein, in other examples, the rendering and cinematic rendering may be performed by a single module or any number of modules. Moreover, while the cinematic replay is shown and described as being performed during gameplay, in other examples, state data may be stored and utilized for rendering of cinematic replays. Like numbers refer to like elements throughout.

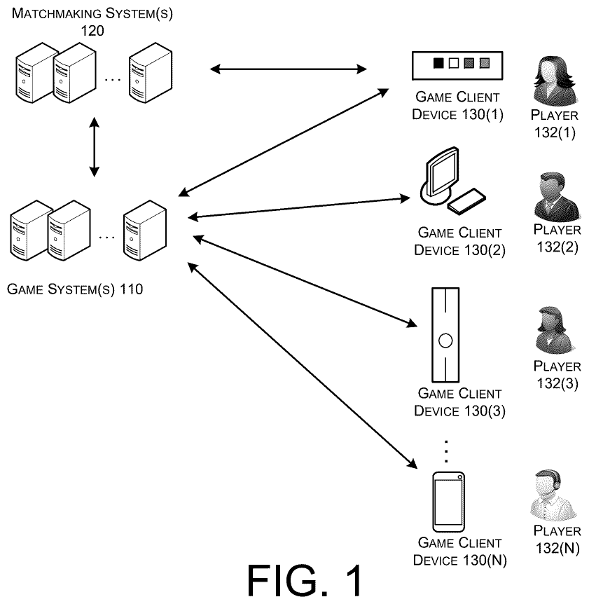

FIG. 1 illustrates a schematic diagram of an example environment 100 with game system(s) 110, matchmaking system(s) 120, and game client device(s) 130 that may provide for capturing simulation state data of gameplay in a video game such that a cinematic replay of the gameplay may be rendered and/or presented, in accordance with example embodiments of the disclosure.

The example environment 100 may include one or more player(s) 132(1), 132(2), 132(3), . . . 132(N), hereinafter referred to individually or collectively as player(s) 132, who may interact with respective game client device(s) 130(1), 130(2), 130(3), . . . 130(N), hereinafter referred to individually or collectively as game client device(s) 130 via respective input device(s).

The game client device(s) 130 may receive game state information from the one or more game system(s) 110 that may host the online game played by the player(s) 132 of environment 100. The game state information may be received repeatedly and/or continuously and/or as events of the online game transpire. The game state information may be based at least in part on the interactions that each of the player(s) 132 have in response to events of the online game hosted by the game system(s) 110.

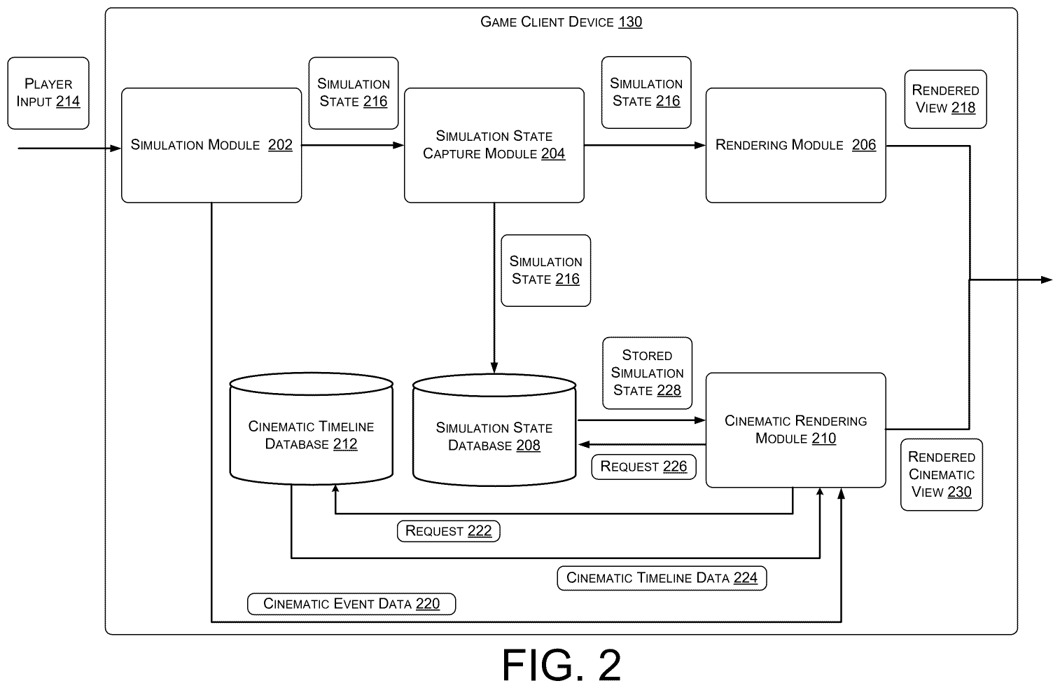

The game client device(s) 130 may be configured to render content associated with the online game to respective player(s) 132 based at least on the game state information. More particularly, the game client device(s) 130 may use the most recent game state information to render current events of the online game as content. This content may include video, audio, haptic, combinations thereof, or the like content components. The game client device(s) 130 may further be configured to capture the game state information for use in conjunction with a cinematic replay functionality. These functions are described in additional detail below with regard to FIGS. 2-6.

As events transpire in the online game, the game system(s) 110 may update game state information and send that game state information to the game client device(s) 130. For example, if the player(s) 132 are playing an online soccer game, and the player 132 playing one of the goalies moves in a particular direction, then that movement and/or goalie location may be represented in the game state information that may be sent to each of the game client device(s) 130 for rendering the event of the goalie moving in the particular direction. In this way, the content of the online game is repeatedly updated throughout game play. Further, the game state information sent to individual game client device(s) 130 may be a subset or derivative of the full game state maintained at the game system(s) 110. For example, in a team deathmatch game, the game state information provided to a game client device 130 of a player may be a subset or derivative of the full game state generated based on the location of the player in the game simulation.

When the game client device(s) 130 receive the game state information from the game system(s) 110, a game client device 130 may render updated content associated with the online game to its respective player 132. This updated content may embody events that may have transpired since the previous state of the game (e.g., the movement of the goalie).

The game client device(s) 130 may accept input from respective player(s) 132 via respective input device(s). The input from the player(s) 132 may be responsive to events in the online game. For example, in an online basketball game, if a player 132 sees an event in the rendered content, such as an opposing team's guard blocking the point, the player 132 may use his/her input device to try to shoot a three-pointer. The intended action by the player 132, as captured via his/her input device, may be received by the game client device 130 and sent to the game system(s) 110.

The game client device(s) 130 may be any suitable device, including, but not limited to a Sony Playstation® line of systems, a Nintendo Switch® line of systems, a Microsoft Xbox® line of systems, any gaming device manufactured by Sony, Microsoft, Nintendo, or Sega, an Intel-Architecture (IA)® based system, an Apple Macintosh® system, a netbook computer, a notebook computer, a desktop computer system, a set-top box system, a handheld system, a smartphone, a personal digital assistant, a virtual reality system, an augmented reality system, combinations thereof, or the like. In general, the game client device(s) 130 may execute programs thereon to interact with the game system(s) 110 and render game content based at least in part on game state information received from the game system(s) 110. Additionally, the game client device(s) 130 may send indications of player input to the game system(s) 110. Game state information and player input information may be shared between the game client device(s) 130 and the game system(s) 110 using any suitable mechanism, such as application program interfaces (APIs).

The game system(s) 110 may receive inputs from various player(s) 132 and update the state of the online game based thereon. As the state of the online game is updated, the state may be sent to the game client device(s) 130 for rendering online game content to player(s) 132. In this way, the game system(s) 110 may host the online game.

The example environment 100 may further include matchmaking system(s) 120 to match player(s) 132 who wish to play the same game and/or game mode with each other and to provide a platform for communication between the player(s) 132 playing online games (e.g., the same game and/or different games). The matchmaking system(s) 120 may receive an indication from the game system(s) 110 of player(s) 132 who wish to play an online game.

The matchmaking system(s) 120 may attempt matchmaking between player(s) 132. The matchmaking system(s) 120 may access information about the player(s) 132 who wish to play a particular online game, such as from a player database. A user account for each of the player(s) 132 may associate various information about the respective player(s) 132 and may be stored in the player database and accessed by the matchmaking system(s) 120.

Player(s) 132 may be matched according to one or more metrics associated with the player(s) 132 such as skill at a particular game. In addition to or alternatively to skill scores, player(s) 132 may be matched on a variety of other factors. Some example matchmaking factors may be related to behavior in addition to skill and may include a player's playstyle. For example, when matching player(s) 132 as a team for a team deathmatch, the matchmaking system(s) 120 may favor matching player(s) 132 that exhibit similar levels of aggression or a mix of levels of aggression. This may alleviate the frustration experienced by players when deathmatch teams split up due to different players utilizing different tactics. Splitting a deathmatch team into different groups using different tactics can often result in a loss to an opposing team operating as a single unit with a shared tactical approach. The aspects of players' playstyle utilized for different genres or different individual games may vary from example to example.

Some other example matchmaking factors may be character or setup related such as character class, team choice, position or role preference, and so on. For example, when matching player(s) 132 for an online roleplaying game, the matchmaking system(s) 120 may consider the character classes of the player(s) 132. Other matchmaking factors may be related to teammates or teams of the player(s) 132. In an example, the matchmaking may match a player 132 to other players the player 132 plays with regularly.

Having matched the player(s) 132, the matchmaking system(s) 120 may instruct generation of instance(s) of the online game(s) for the match(es). More particularly, the matchmaking system(s) 120 may request the game system(s) 110 instantiate an online game between the matched player(s) 132. For example, the matchmaking system(s) 120 may provide connection information for the game client device(s) 130 to the game system(s) 110 for instantiation of an instance of the online game between the matched player(s) 132. As discussed herein, instances and matches of an online game may be used interchangeably and may refer to a shared gameplay environment in which matched players play in the online game, whether a single map, multiple connected maps, or a gameplay world. In some examples, a server may host the match or instance of the game for the matched players.

As a player 132 engages in additional gameplay, the gaming system(s) 110 may provide the matchmaking system(s) 120 with some or all of the game state information. The matchmaking system(s) 120 may store the game state information or data derived from the game state information. In this manner, behavior data and/or gameplay history for the player 132 may remain up-to-date, even if or as the player's behaviors and playstyle evolve over time.

As mentioned above, the matchmaking system(s) 120 may further provide a platform for communication between the player(s) 132 playing online games (e.g., the same game and/or different games). Depending on the implementation, the matchmaking system(s) 120 may provide a social platform in which player(s) 132 may utilize friends list, communities and/or groups, and other connections to establish relationships with other player(s) 132. The matchmaking system(s) 120 may also provide direct messaging, group messaging, public messaging, chat, and/or other communications functionality to allow player(s) 132 to communicate via the social platform.

In addition, the matchmaking system(s) 120 (or the game system(s) 110) may include in-match communications functionality that may allow player(s) 132 to communicate with other player(s) 132 while in matches or instances of the online game.

As discussed above, the game client device(s) 130 may include functionality to capture game simulation state data and/or to provide cinematic replay renderings of the gameplay.

FIG. 2 illustrates a schematic diagram of an example game client device 130 that may include functionality for simulation state data capture and cinematic replay generation. As illustrated, the example game client device 130 includes a simulation module 202, a simulation state capture module 204, a rendering module 206, a simulation state database 208, a cinematic rendering module 210 and a cinematic timeline database 212.

During gameplay, the simulation module 202 may operate to maintain and update a simulation state 216 (e.g., which may be or may be based on the game simulation state discussed above with regard to FIG. 1). In some examples, the simulation module 202 may be a game engine or similar component. The simulation module 202 may receive player input 214 from a player and/or simulation state update data from the gaming system(s) 110. Based on the received input 214 and/or update data, the simulation module 202 may update the simulation state 216. The simulation state 216 may include positions and orientations of models and components of models within the simulation state, light sources, camera positions, and so on. The simulation module 202 may output the simulation state 216 to the simulation state capture module 204. In some examples, the simulation module 202 may output the simulation state 216 to the rendering module 206 with the simulation state capture module 204 capturing the simulation state 216 (e.g., the simulation module 202 may be configured for operations with or without the presence of the simulation state capture module 204).

The simulation state capture module 204 may receive or capture the simulation state data 216 from the simulation module 202. The simulation state capture module 204 may then output the simulation state 216 to the rendering module 206 and to the simulation state database 208. For example, the simulation state 216 may be captured by the simulation state capture module 204 and sent to the simulation state database 208 on a per frame basis, a per rendered view basis and/or at other frequencies.

The rendering module 206 may receive the simulation state 216 and operate to generate, based on the simulation state 216, a rendered view 218 that may include a frame or view that is presented to the player.

The simulation state database 208 may receive and store the simulation state 216. In some examples, the simulation state database 208 may store the simulation state 216 as simulation state data. As mentioned above, the simulation state data, as used herein, may refer to a set of simulation states 216 captured for a period of time that correspond to a series of rendered views presented to the player during live gameplay. Depending on the implementation, the simulation states 216 may be stored permanently or temporarily by the capture process. For example, a game client device 130 may have a limited amount of storage space for storing simulation states 216. In such an example, the simulation state database 208, in absence of input from a user, may overwrite old simulation states with new simulation states on a first-in-first-out basis beginning the temporary storage space fills. In other examples, the simulation state capture module 204 and/or the simulation state database 208 may additionally or alternatively include functionality to prioritize subsets of simulation states 216 based on their content. For example, the simulation module 202 may include information in the simulation state 216 indicating events or other context for the simulation states 216 that may be indicative of whether a player will likely want to share the content of the simulation states 216. In a particular example, the simulation state capture module 204 and/or the simulation state database 208 may determine a simulation state 216 is related to an event such as the player gaining an achievement, the player scoring, the player successfully performing an action such as a complex trick, and so on. Simulation states 216 determined to be related to the event may be stored together as simulation state data and given a higher retention priority than simulation states 216 that are related to, for example, an idle period or a failure event (e.g., a failed attempt at a trick, a loss of possession in an eSports game, etc.).

In a particular example, the simulation module 202 may determine a simulation state 216 is related to a cinematic event such as the player striking the winning blow of a fighting game matchup, gaining an achievement, the player scoring, the player successfully performing an action such as a complex trick, and so on. A cinematic event may be a type of event for which a cinematic timeline has been configured for rendering of the simulation state data 216 associated with events of the type of event. For example, in operation of a mixed martial arts (MMA) fighting game, a cinematic event may be a fight ending blow, a fight ending grappling move, or otherwise notable action or period of time in the MMA fight. In some examples, a cinematic event may have additional characteristics or criteria. For example, fight ending kicks to the body of the losing character may be a different type of cinematic event from a fight ending punch to the head of the losing character. In the operation of a soccer game, a cinematic event may be a goal scoring kick or a type of blocking action of a defender (e.g., the goalie).

Once a cinematic event has been determined to have occurred, the simulation module 202 may output, to the cinematic rendering module 210, cinematic event data 220 about the cinematic event and/or cause the rendering module 206 rendering the gameplay to stop rendering views for display.

The cinematic rendering module 210 may request 222 cinematic timeline data 224 from a cinematic timeline database 212 for the type of cinematic event. Based on the cinematic timeline data 224 for the type of cinematic event, the cinematic rendering module 210 may request simulation data for a time range around the time of the cinematic event. For example, the cinematic rendering module may request 226 simulation data 228 for four seconds before the event and three seconds afterwards.

The cinematic rendering module 210 may include functionality to render the rendered cinematic view 230 of the gameplay for presentation to the player. As shown, the cinematic rendering module 210 may then utilize the cinematic timeline data 224 and the simulation data 228 to render a rendered cinematic view 230 of the cinematic event and/or present the rendered cinematic view 230 to the player(s).

More particularly, the cinematic timeline data 224 may include data for a cinematic sequence of “shot(s)” or track(s). A shot may involve a one or more characters that are animated to perform one or more actions in the cinematic replay, one or more cameras (e.g., virtual cameras of the game engine) that may act as viewpoints for the rendering of the rendered cinematic view 230, lighting data for one or more lights that may illuminate the shot, time dilation data that may slow down or speed up the actions of the character (e.g., the passage of time in the cinematic replay), particle effects data, framing weight controls, and/or any other data for rendering the cinematic replay. In an example, the rendered cinematic views 230 may relate to a winning a knockout punch of a MMA match. In such an example, the simulation state data 228 may include models for the two MMA fighters and animation, movement, or pose information for the models over the course of the time range.

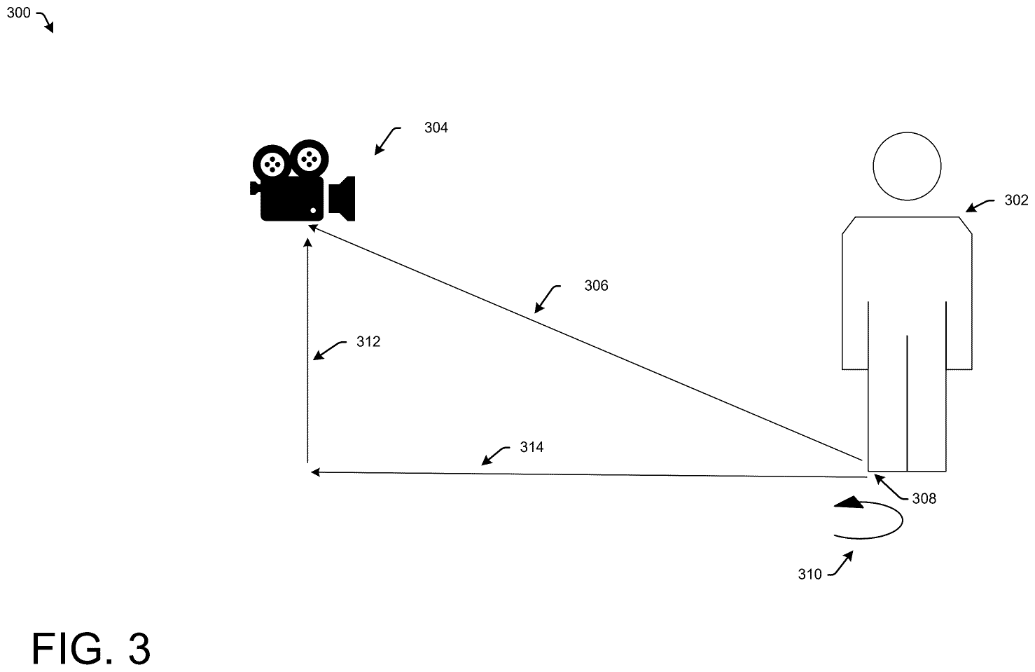

The one or more cameras may be anchored in the virtual environment to a static location, an offset from a portion of a character or object, an offset from a midpoint of two or more characters or objects, and so on. An example of such camera shot data is shown in FIG. 3.

More particularly, FIG. 3 illustrates a diagram 300 of a camera configuration for a shot of a cinematic timeline. More particularly, the camera 304 of the shot is anchored to and focused on the player character 302 (e.g., the camera's own rotation or aim is locked to the face of the player character 302). In other examples involving two players, the focus may be between the characters. A framing weight control may weight the views toward and/or away from one or more of the character(s), object(s) or other location(s) in the virtual environment. As illustrated, the camera may have a camera offset 306 from an orbit point 308 (e.g., the base of the model of the character 302). The camera offset 306 may be configured as a left/right rotation 310 about the orbit point 308, and up/down offset 312 and a forward/back offset 314. The camera offset 306 may dynamically change over the course of the shot of the cinematic timeline. In some examples, the movement of the camera may be configurable to mimic the movements of a boom arm to which the camera is attached. Further, in some examples, the camera position and/or orientation may be determined by applying a transform to the orbit point 308 based on the camera offset 306.

Some examples may provide for additional configuration of the camera 304. For example, a camera 304 may be configurable to: mimic the properties of a type of real world camera; provide configurable lens properties such as aperture, focus distance, focal length, shutter speed, and so on; provide configurable clipping planes; provide for proxy camera shake; and the like.

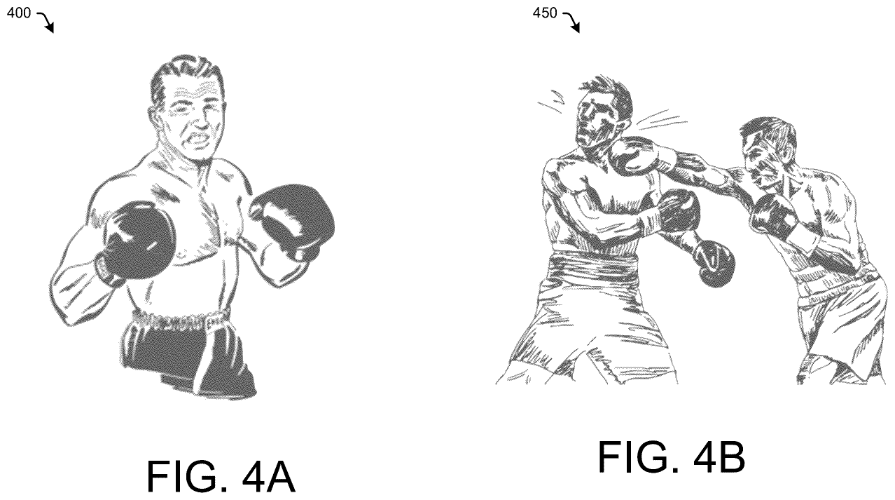

At least some of the shot configuration to render rendered cinematic views 230 for a shot in the cinematic timeline may be independent of the configuration to render the gameplay views that may be rendered during gameplay. An example of such independence of the camera shot data is shown in FIGS. 4A and 4B.

More particularly, FIGS. 4A and 4B illustrates views 400 and 450 of a match in a boxing video game the moment before and the moment after a cinematic event occurs, respectively. Specifically, view 400 is a frame of the rendered view 218 a moment before a fight winning knockout punch begins and view 450 is a frame of the rendered cinematic view data at the moment the knockout punch lands. As discussed above, the configuration of the shot to produce view 450 (e.g., camera offset, lighting, time dilation, and other effects) may be partially or entirely independent of the configuration utilized in rendering the rendered view 400 during gameplay. Further, the configuration of each shot may be at least partially or entirely independent of the configuration of other shots in the cinematic timeline.

Returning to the MMA fight scenario as another example, a cinematic timeline may include cinematic views that are configured independently from the configuration of the gameplay views which, in view 400, is shown in a first person perspective that is focused on the opponent character. Specifically, a first shot of a cinematic timeline may include the two fighters in a framing view similar to that shown in view 450 of FIG. 4B, a second shot of the cinematic timeline may shift the view to frame mostly the losing character's face as the punch approaches contact with a zoom out and orbit around the losing character as the character falls to the mat after the punch lands and a third shot of the cinematic timeline may shift to a view looking up at the winning character across the position of the losing character (e.g., over the losing character who has fallen to the mat). During the three shots of the timeline, the lighting may be changed from the arena lighting of gameplay to spotlights that highlight the characters while pitching the remainder of the arena in darkness. The playback speed or time dilation may vary throughout the shots to give bullet time or other slow motion effects. For example, time dilation may be increased to reduce the playback speed as the hit approaches and connects. The playback speed may then be increased as the losing character falls to the mat of the arena. Further, effects may be started, stopped or modified throughout the shots of the timeline. For example, the particle effects for blood and sweat may be increased when the knockout punch lands to increase the feeling of a devastating blow being landed.

In some examples, the changes in the various parameters of a shot over the time period of the shot may be a smooth curve, stepped, continuous, linear and so on. For example, a time dilation curve may cause the time dilation of a shot to change from a near stop to a real time playback rate in a smooth geometric or exponential increase such that the playback speed increases slowly at first. Once the playback speed reaches half speed, the playback speed may then rapidly increase until it reaches real time playback speed. Of course, depending on the implementation a time dilation curve of a shot may increase and decrease the time dilation effect a plurality of times over the course of the shot and/or may remain at a same value throughout the shot.

As the frames of the rendered cinematic view of the shot are generated, the cinematic rendering module 210 may output the rendered cinematic view 230 to a player via a display. At the end of a shot of a timeline, the cinematic rendering module 210 may begin rendering frames for the next shot of the rendered cinematic view 230. In some examples, each shot may be associated with a different portion of the time window of the cinematic event (e.g., as in the above example) and/or some of the shots may partially or entirely overlap in the time window of the cinematic event. In addition, the cinematic timeline data may include transition effects for the transition between different shots of the cinematic timeline. As each shot is completed, the cinematic rendering module 210 may render or perform the transition and continue with the next shot of the cinematic timeline.

After the last shot of the timeline has been rendered and/or output, the cinematic rendering module 210 may notify the simulation module 202 that the rendering of the cinematic view of the cinematic event is complete. The simulation module 202 may then cause the main rendering module to resume with gameplay rendering if the cinematic event was not the end of the gameplay or the simulation module 202 may begin handling the post match score presentation or the like if the cinematic event ended the gameplay.

The cinematic timeline and cinematic rendering module 210 may allow for any number of effects to be applied to the simulation state data which may vary from example to example. As such, examples are not limited in the effects discussed herein. Further, the cinematic timeline and the shots of the cinematic timeline data may be received separately and/or be combined and are not limited in their form.

It should be noted that, though FIGS. 1 and 2 include certain modules, components, and/or databases, the functionality discussed above may be performed by different combinations of modules, components, and/or databases. For example, the cinematic rendering module 210 may perform operations of the rendering module 206 and vice versa. Other examples may include additional elements and/or may not include some or any of the elements illustrated, with different modules, components, and/or databases performing some or all of the operations described herein.

Of course, examples are not limited to those specifically described above and may include other variations such as an example in which the game system(s) 110 performs the cinematic replay functionality without involvement of the game client devices 130 (e.g., other than as interface devices). Other variations would be apparent based on this disclosure.

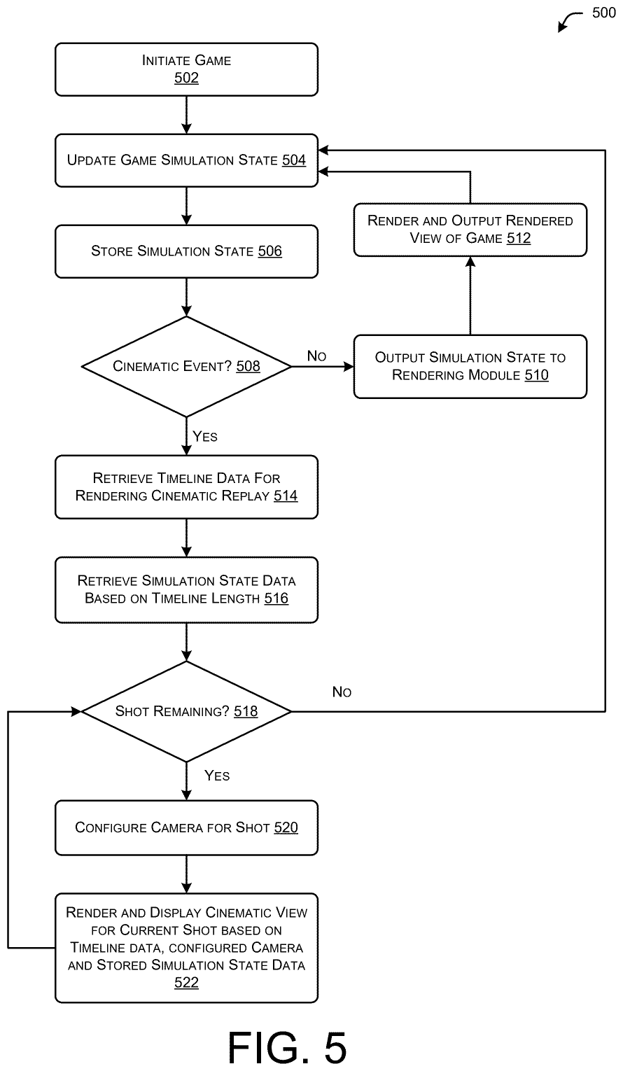

FIG. 5 illustrates a flow diagram of an example method 500 that may provide for capture of simulation state(s) from gameplay of a player and for rendering of a cinematic replay of the gameplay, for example, upon occurrence of a gameplay event, in accordance with example embodiments of the disclosure. The method 500 may be performed by the game client device 130 of the environment 100.

At block 502, the game client device may initiate a game (possibly in conjunction with an online game system). The game client device may update the simulation state of the game at block 504. In some examples, the game client device may update the game simulation state based on player inputs from a player input device and/or game state updates received from a game system hosting the game (e.g., if the game is an online game).

At block 506, the simulation state database may store the simulation state (e.g., for later use in rendering cinematic replay views). The game client device may then determine whether a cinematic event has occurred at block 508. If so, the process may continue to block 514. Otherwise, the process continues to block 510.

At block 510, the game client device may output the simulation state for rendering. Next, at block 512, the rendering module may receive the simulation state, then render and output a rendered view of the game based thereon.

Returning to block 514, a cinematic rendering module may retrieve cinematic timeline data for rendering a cinematic replay of the cinematic event. Then, at block 516, based on the cinematic timeline data, the cinematic rendering module may retrieve simulation state data for rendering the cinematic replay views. In some examples, the cinematic rendering module may retrieve simulation state data for a time period around the cinematic event to be included in the cinematic replay views.

At block 518, the cinematic rendering module may determine whether the timeline data includes a “shot” that has not been rendered. If so, the process may continue to block 520. Otherwise, the process may return to block 504 for additional gameplay or for post gameplay functionality.

At block 520, the cinematic rendering module may configure the camera(s) of the shot. Then, at block 522, the cinematic rendering module may render and display a cinematic view for the current shot based on the cinematic timeline data, the configured camera(s) and retrieved simulation state data. The process may then return to block 518.

It should be noted that some of the operations of method 500 may be performed out of the order presented (e.g., block 520 could be performed for all shots of the cinematic timeline data before block 518 in some embodiments), with additional elements, and/or without some elements. Some of the operations of methods 500 may further take place substantially concurrently and, therefore, may conclude in an order different from the order of operations shown above.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and are believed to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

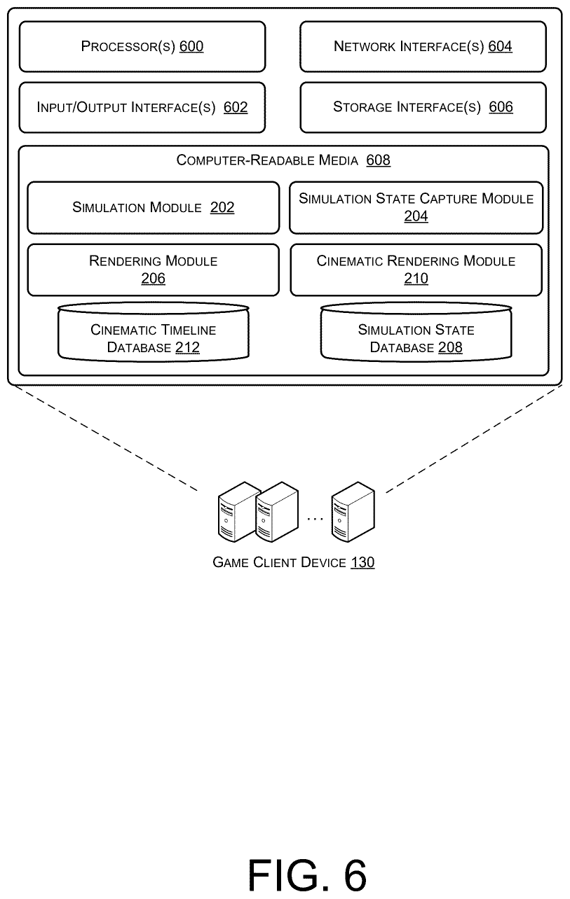

FIG. 6 illustrates a block diagram of example game client device(s) 130 that may provide for capturing simulation state(s) from gameplay of a player and for rendering a cinematic replay of the gameplay, in accordance with examples of the disclosure. The game client device(s) 130 may include one or more processor(s) 600, one or more input/output (I/O) interface(s) 602, one or more network interface(s) 604, one or more storage interface(s) 606, and computer-readable media 608.

In some implementations, the processor(s) 600 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip system(s) (SOCs), complex programmable logic devices (CPLDs), etc. Additionally, each of the processor(s) 600 may possess its own local memory, which also may store program modules, program data, and/or one or more operating system(s). The one or more processor(s) 600 may include one or more cores.

The one or more input/output (I/O) interface(s) 602 may enable the game client device(s) 130 to detect interaction with a user and/or other system(s), such as one or more game system(s) 110. The I/O interface(s) 602 may include a combination of hardware, software, and/or firmware and may include software drivers for enabling the operation of any variety of I/O device(s) integrated on the game client device(s) 130 or with which the game client device(s) 130 interacts, such as displays, microphones, speakers, cameras, switches, and any other variety of sensors, or the like.

The network interface(s) 604 may enable the game client device(s) 130 to communicate via the one or more network(s). The network interface(s) 604 may include a combination of hardware, software, and/or firmware and may include software drivers for enabling any variety of protocol-based communications, and any variety of wireline and/or wireless ports/antennas. For example, the network interface(s) 604 may comprise one or more of a cellular radio, a wireless (e.g., IEEE 802.1x-based) interface, a Bluetooth® interface, and the like. In some embodiments, the network interface(s) 604 may include radio frequency (RF) circuitry that allows the game client device(s) 130 to transition between various standards. The network interface(s) 604 may further enable the game client device(s) 130 to communicate over circuit-switch domains and/or packet-switch domains.

The storage interface(s) 606 may enable the processor(s) 600 to interface and exchange data with the computer-readable medium 608, as well as any storage device(s) external to the game client device(s) 130.

The computer-readable media 608 may include volatile and/or nonvolatile memory, removable and non-removable media implemented in any method or technology for storage of information, such as computer-readable instructions, data structures, program modules, or other data. Such memory includes, but is not limited to, random access memory (RAM), read-only memory (ROM), electrically erasable programmable read-only memory (EEPROM), flash memory or other memory technology, CD-ROM, digital versatile discs (DVD) or other optical storage, magnetic cassettes, magnetic tape, magnetic disk storage or other magnetic storage devices, RAID storage system(s), or any other medium which can be used to store the desired information and which can be accessed by a computing device. The computer-readable media 608 may be implemented as computer-readable storage media (CRSM), which may be any available physical media accessible by the processor(s) 600 to execute instructions stored on the computer readable media 608. In one basic implementation, CRSM may include RAM and Flash memory. In other implementations, CRSM may include, but is not limited to, ROM, EEPROM, or any other tangible medium which can be used to store the desired information and which can be accessed by the processor(s) 600. The computer-readable media 608 may have an operating system (OS) and/or a variety of suitable applications stored thereon. The OS, when executed by the processor(s) 600 may enable management of hardware and/or software resources of the game client device(s) 130.

Several functional blocks having instruction, data stores, and so forth may be stored within the computer-readable media 608 and configured to execute on the processor(s) 600. The computer readable media 608 may have stored thereon a simulation module 202, a simulation state capture module 204, a rendering module 206, a simulation state database 208, a cinematic rendering module 210 and a cinematic timeline database 212. It will be appreciated that each of the functional blocks 202-212 may have instructions stored therein that, when executed by the processor(s) 600, may enable various functions pertaining to the operations of game client device(s) 130.

The illustrated aspects of the claimed subject matter may also be practiced in distributed computing environments where certain tasks are performed by remote processing devices that are linked through a communications network. In a distributed computing environment, program modules can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. As an example, embodiments of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system, comprising:
one or more processors; and
one or more computer-readable media storing computer-executable instructions that, when executed by the one or more processors, cause the one or more processors to perform operations comprising:
determining a cinematic rendering event has occurred during gameplay of a video game based on simulation state data for the video game, the simulation state data including one or more simulation states, the one or more simulation states including at least a model and pose state of an avatar of a player in a video game simulation;
receiving previously stored simulation state data for the video game including one or more prior simulation states, wherein the previously stored simulation state data is associated with a prior time in the gameplay before a time in the gameplay associated with the simulation state data and the previously stored simulation state data was previously rendered as one or more previously rendered views;
rendering a plurality of cinematic rendered views based at least in part on a cinematic rendering timeline, the one or more simulation states of the simulation state data, and the one or more prior simulation states of the previously stored simulation state data, wherein:
the cinematic rendering timeline includes at least a first shot and a second shot;
the rendering of a first portion of the plurality of cinematic rendered views for the cinematic rendering timeline is based on a first configuration associated with the first shot; and
the rendering of a second portion of the plurality of cinematic rendered views for the cinematic rendering timeline is based on a second configuration associated with the second shot; and
outputting, to a computing device, the plurality of cinematic rendered views for display.

2. The system of claim 1, wherein the first configuration associated with the first shot includes a first camera for rendering at least part of the first portion of the plurality of cinematic rendered views and the second configuration associated with the second shot includes a second camera for rendering at least part of the second portion of the plurality of cinematic rendered views.

3. The system of claim 1, wherein the one or more previously rendered views were rendered based on a third configuration that is different from the first configuration.

4. The system of claim 3, wherein:
at least part of the first portion of the plurality of cinematic rendered views and at least part of the one or more previously rendered views are generated based on at least a same portion of the previously stored simulation state data;
the first configuration includes one or more lights for rendering at least the part of the first portion of the plurality of cinematic rendered views; and
the third configuration includes one or more different lights for rendering at least the part of the previously rendered views.

5. The system of claim 3, wherein:
at least part of the first portion of the plurality of cinematic rendered views and at least part of the one or more previously rendered views are generated based on at least a same portion of the previously stored simulation state data;
the first configuration includes a time dilation for rendering at least the part of the first portion of the plurality of cinematic rendered views; and
the third configuration includes a different time dilation for rendering at least the part of the previously rendered views.

6. The system of claim 3, wherein:
at least part of the first portion of the plurality of cinematic rendered views and at least part of the one or more previously rendered views are generated based on at least a same portion of the previously stored simulation state data;
the first configuration includes a value for a visual effect for rendering at least the part of the first portion of the plurality of cinematic rendered views; and
the third configuration includes a different value for the visual effect for rendering at least the part of the previously rendered views.

7. The system of claim 1, the operations further comprising:
determining a type of the cinematic rendering event, wherein the determined type is associated with the cinematic rendering timeline; and
determining to render the plurality of cinematic rendered views based at least in part on the cinematic rendering timeline based on the determined type of the cinematic rendering event.

8. A computer-implemented method comprising:
determining a cinematic rendering event has occurred during gameplay of a video game based on simulation state data for the video game, the simulation state data including one or more simulation states, the one or more simulation states including at least a model and pose state of an avatar of a player in a video game simulation;
receiving previously stored simulation state data for the video game including one or more prior simulation states, wherein the previously stored simulation state data is associated with a prior time in the gameplay before a time in the gameplay associated with the simulation state data and wherein the previously stored simulation state data was previously rendered as one or more previously rendered views;
rendering a plurality of cinematic rendered views based at least in part on a cinematic rendering timeline, the one or more simulation states of the simulation state data, and the one or more prior simulation states of the previously stored simulation state data, wherein:
the cinematic rendering timeline includes at least a first shot and a second shot;
the rendering of a first portion of the plurality of cinematic rendered views for the cinematic rendering timeline is based on a first configuration associated with the first shot; and
the rendering of a second portion of the plurality of cinematic rendered views for the cinematic rendering timeline is based on a second configuration associated with the second shot; and
outputting, to a computing device, the plurality of cinematic rendered views, for display.

9. The computer-implemented method of claim 8, wherein the first configuration associated with the first shot includes a first camera for rendering at least part of the first portion of the plurality of cinematic rendered views and the second configuration associated with the second shot includes a second camera for rendering at least part of the second portion of the plurality of cinematic rendered views.

10. The computer-implemented method of claim 8, wherein the one or more previously rendered views were rendered based on a third configuration that is different from the first configuration.

11. The computer-implemented method of claim 10, wherein:
at least part of the first portion of the plurality of cinematic rendered views and at least part of the one or more previously rendered views are generated based on at least a same portion of the previously stored simulation state data;
the first configuration includes one or more lights for rendering at least the part of the first portion of the plurality of cinematic rendered views; and
the third configuration includes one or more different lights for rendering at least the part of the previously rendered.

12. The computer-implemented method of claim 10, wherein:
at least part of the first portion of the plurality of cinematic rendered views and at least part of the one or more previously rendered views are generated based on at least a same portion of the previously stored simulation state data;
the first configuration includes a time dilation for rendering at least the part of the first portion of the plurality of cinematic rendered views; and
the third configuration includes a different time dilation for rendering at least the part of the previously rendered views.

13. The computer-implemented method of claim 10, wherein:
at least part of the first portion of the plurality of cinematic rendered views and at least part of the one or more previously rendered views are generated based on at least a same portion of the previously stored simulation state data;
the first configuration includes a value for a visual effect for rendering at least the part of the first portion of the plurality of cinematic rendered views; and
the third configuration includes a different value for the visual effect for rendering at least the part of the previously rendered views.

14. The computer-implemented method of claim 8, further comprising:
determining a type of the cinematic rendering event, wherein the determined type is associated with the cinematic rendering timeline; and
determining to render the plurality of cinematic rendered views based at least in part on the cinematic rendering timeline based on the determined type of the cinematic rendering event.

15. One or more non-transitory computer-readable media storing computer-executable instructions that, when executed by one or more processors, cause the one or more processors to perform operations comprising:
determining a cinematic rendering event has occurred during gameplay of a video game based on simulation state data for the video game, the simulation state data including one or more simulation states, the one or more simulation states including at least a model and pose state of an avatar of a player in a video game simulation;
receiving previously stored simulation state data for the video game including one or more prior simulation states, wherein the previously stored simulation state data is associated with a prior time in the gameplay before a time in the gameplay associated with the simulation state data and wherein the previously stored simulation state data was previously rendered as one or more previously rendered views;
rendering a plurality of cinematic rendered views based at least in part on a cinematic rendering timeline, the one or more simulation states of the simulation state data, and the one or more prior simulation states of the previously stored simulation state data, wherein:
the cinematic rendering timeline includes at least a first shot and a second shot;
the rendering of a first portion of the plurality of cinematic rendered views for the cinematic rendering timeline is based on a first configuration associated with the first shot; and
the rendering of a second portion of the plurality of cinematic rendered views for the cinematic rendering timeline is based on a second configuration associated with the second shot; and
outputting, to a computing device, the plurality of cinematic rendered views for display.

16. The one or more non-transitory computer-readable media of claim 15, wherein the first configuration associated with the first shot includes a first camera for rendering at least part of the first portion of the plurality of cinematic rendered views and the second configuration associated with the second shot includes a second camera for rendering at least part of the second portion of the plurality of cinematic rendered views.

17. The one or more non-transitory computer-readable media of claim 15, wherein the one or more previously rendered views were rendered based on a third configuration that is different from the first configuration.

18. The one or more non-transitory computer-readable media of claim 17, wherein:
at least part of the first portion of the plurality of cinematic rendered views and at least part of the one or more previously rendered views are generated based on at least a same portion of the previously stored simulation state data;
the first configuration includes one or more lights for rendering at least the part of the first portion of the plurality of cinematic rendered views; and
the third configuration includes one or more different lights for rendering at least part of the previously rendered views.

19. The one or more non-transitory computer-readable media of claim 17, wherein:
at least part of the first portion of the plurality of cinematic rendered views and at least part of the one or more previously rendered views are generated based on at least a same portion of the previously stored simulation state data;
the first configuration includes a time dilation for rendering at least the part of the first portion of the plurality of cinematic rendered views; and
the third configuration includes a different time dilation for rendering at least the part of the previously rendered views.

20. The one or more non-transitory computer-readable media of claim 15, the operations further comprising:
determining a type of the cinematic rendering event, wherein the determined type is associated with the cinematic rendering timeline; and
determining to render the plurality of cinematic rendered views based at least in part on the cinematic rendering timeline based on the determined type of the cinematic rendering event.
